(19) United States
(12) Patent Application Publication
(10) Pub. No.: US 2020/0237160 A1
(43) Pub. Date: Jul. 30, 2020

(54) MOLD, DISH, FOOD CONTAINER, AND METHOD FOR MANUFACTURING THE MOLD

(71) Applicant: SECT CONSULTANT,INC., Hiroshima-shi, Hiroshima (JP)

(72) Inventor: Rie KUDO, Hiroshima-shi (JP)

(73) Assignee: SECT CONSULTANT,INC., Hiroshima-shi, Hiroshima (JP)

(21) Appl. No.: 16/637,747

(22) PCT Filed: Oct. 15, 2018
(86) PCT No.: PCT/JP2018/038322

§ 371 Date: Feb. 8, 2020

(30) Foreign Application Priority Data
Oct. 16, 2017 (JP) 2017-213217

(51) Int. Cl. A47J 43/20; A47G 19/30; A47G 19/02

(52) U.S. Cl. CPC A47J 43/20; A47G 19/02; A47G 19/30

(57) ABSTRACT

A mold for creating an image on an article has an uneven surface having a depth that varies in accordance with brightness of an original image, and being covered with a light-transmitting colored material in a color different from a color of the article.

### TECHNICAL FIELD

The present invention relates to a mold, a dish, and a food container for creating an image having high-contrast brightness, and a method of manufacturing the mold.

### BACKGROUND ART

The following methods have been typically used to express, on a place other than paper, images like photographs with high-contrast and complex brightness information. A specific printer capable of printing an image on a three-dimensional (3D) object such as what is called a “UV printer” may be used. Alternatively, a seal or sticker prepared in advance may be attached to a 3D object by hydraulic transfer, for example.

If the material is hard like glass or metal, for example, an image is generally created on the surface of the material by stippling with an engraving machine, for example.

In order to apply an image to food, the following method is known as disclosed in Patent Document 1, for example. A laser beam is used to irradiate the food not to reach an edible portion to form an uneven surface, which is colored by edible ink.

### CITATION LIST

### Patent Document

Patent Document 1: Japanese Unexamined Patent Publication No. 2018-38382

### SUMMARY OF THE INVENTION

### Technical Problem

With the use of a particular printer such as a UV printer, however, an object to be printed needs to be in a shape or made of a material suitable for printing. It is thus difficult to apply the printer to, for example, a food containing much water or a soft food. It is also difficult to attach a seal or sticker to a food containing much water or a soft food.

The stippling with an engraving machine requires a hard material capable of reproducing fine points. It is thus difficult to apply the stippling to a soft food. Mass-production of such fine processed food is also difficult.

In the method of Patent Document 1, the laser beam is used to irradiate only a portion other than the edible portion, and no image cannot be created on the edible portion. In addition, the coloring with edible ink may deteriorate the healthy impression of food and may be avoided by some companies or consumers.

There is also a demand for easily creating an image with high-contrast brightness on objects besides food.

The present invention was made in view of the problem. It is an objective of the present invention to create an image with high-contrast brightness on an article without using any particular printer, engraving machine, laser irradiator, or the like.

### Solution of the Problem

In order to achieve the objective, a first aspect of the present invention provides a mold for creating an image on an article. The mold has an uneven surface having a depth that varies in accordance with brightness of an original image, and being covered with a light-transmitting colored material in a color different from a color of the article.

This configuration allows the article to have, for example, the following uneven surface. The lower the brightness of the original image is, the deeper the uneven surface is. Alternatively, the higher the brightness of the original image is, the deeper the uneven surface is. When the uneven surface is covered with the colored material, the color seems different between a deeper part and a shallower part of the uneven surface for the reason that the colored material transmits light. This difference in color corresponds to the brightness of the original image. For example, a part of the original image with a lower brightness is in a darker color, whereas a part of the original image with a higher brightness is in a paler color. This allows representation of high-contrast gradation according to the depth of the uneven surface and a high-definition image to be obtained.

That is, since the article has the uneven surface having the depth that varies depending on parts thereof and covered with the colored material, an image with high-contrast brightness can be created on the article without using any particular printer, engraving machine, laser irradiator, or the like. The article may include dishes, food containers, and food, for example.

In a second aspect of the present invention, the uneven surface is configured such that the lower the brightness of the original image is, the deeper the uneven surface is.

For example, if the colored material has a darker color than the article, the uneven surface may include a recess that is deeper as the brightness of the original image decreases. The deeper part seems then darker. With this configuration, the brightness of the original image corresponds to the density of the color.

In a third aspect of the present invention, the uneven surface is configured such that the higher the brightness of the original image is, the deeper the uneven surface is.

For example, if the colored material has a paler color than the article, the uneven surface may include a recess that is deeper as the brightness of the original image increases. The deeper part seems then darker. With this configuration, the brightness of the original image corresponds to the density of the color.

A fourth aspect of the present invention provides a dish including the mold of any one of the first to third aspects at the bottom.

This configuration allows the dish to have the uneven surface at the bottom. When a liquid seasoning as the colored material is poured onto the dish, the uneven surface is covered with the liquid seasoning. When the dish is viewed from above in this state, the color seems different between a deeper part and a shallower part of the uneven surface. This allows creation of an image on the dish.

A fifth aspect of the present invention provides a food container including the mold of any one of the first to third aspects at the bottom.

This configuration allows the food container to have the uneven surface at the bottom. This allows creation of an image as in the fourth aspect. While the food container contains a soft food such as a jelly, pudding, or tofu, the shape of the uneven surface is transferred onto the food. This allows the food to have the uneven surface. When the liquid seasoning as the colored material is poured to cover the uneven surface, the color seems different between a deeper part and a shallower part of the uneven surface. This allows creation of an image on an edible portion of the food without using any edible ink.

A sixth aspect of the present invention provides a method of manufacturing the mold. The method includes: determining brightness of the original image; determining density corresponding to a thickness of the colored material; and setting depths of parts of the uneven surface to reproduce the density correlated with the brightness.

This method reproduces the density corresponding to the brightness of the original image using the depths of the respective parts of the uneven surface.

### Advantages of the Invention

The present invention can create an image with high-contrast brightness on an article without using any particular printer, engraving machine, laser irradiator, or the like.

### BRIEF DESCRIPTION OF THE DRAWINGS

FIG. 1 is a plan view of a dish including a mold according to a first embodiment of the present invention at the bottom.

FIG. 2 is a cross-sectional view taken along line II-II of FIG. 1.

FIG. 3 is a view corresponding to FIG. 2 and illustrating the dish containing seasoning poured thereon.

FIG. 4 is a top view of the dish containing seasoning powered thereon.

FIG. 5 is a flowchart representing a manufacturing procedure of the mold.

FIG. 6 is a graph representing the relationship between the density and depth of a liquid.

FIG. 7 is a view illustrating how to obtain distance information on the basis of brightness information.

FIG. 8A is a view illustrating the brightness information on an original image.

FIG. 8B is an image obtained by converting the brightness information shown in FIG. 8A into distance information.

FIG. 9 is a view illustrating an example machine tool.

FIG. 10 is a longitudinal sectional view of a food container including a mold according to a second embodiment of the present invention at the bottom.

FIG. 11A is a view corresponding to FIG. 10 and illustrating a food container containing a pudding mixture (liquid) poured therein.

FIG. 11B is a cross-sectional view of finished pudding with a sauce poured thereon.

FIG. 12 is a top view of pudding with a sauce poured thereon.

FIG. 13 is a cross-sectional view of a mold according to a third embodiment of the present invention.

FIG. 14A is a cross-sectional view of bread immediately before being pressed by the mold.

FIG. 14B is a cross-sectional view of the bread being pressed by the mold.

FIG. 15 is a cross-sectional view of the bread with a sauce poured thereon.

FIG. 16A is a view illustrating the case in which image data is separated into cyan, magenta, and yellow in accordance with a fourth embodiment of the present invention.

FIG. 16B is a view illustrating three-dimensional data of cyan, magenta, and yellow images.

FIG. 17A is a cross-sectional view of a mold with a cyan jelly liquid poured thereon.

FIG. 17B is a cross-sectional view of the cyan jelly transferred to a container.

FIG. 17C is a cross-sectional view of the container with a colorless transparent jelly liquid poured therein.

FIG. 17D is a cross-sectional view of a container with a laminate of cyan, magenta, and yellow jelly.

FIG. 18 is a view illustrating the case in which actual image data is separated into cyan, magenta, and yellow.

FIG. 19 is a top view of a laminate of cyan, magenta, and yellow jelly.

FIG. 20 is a view illustrating how to form a layer mold in view of perspective.

### DESCRIPTION OF EMBODIMENTS

Embodiments of the present invention will be described below in detail with reference to the drawings. The following description of preferred embodiments is merely illustrative in nature and is not intended to limit the present invention and applications or uses thereof.

### First Embodiment

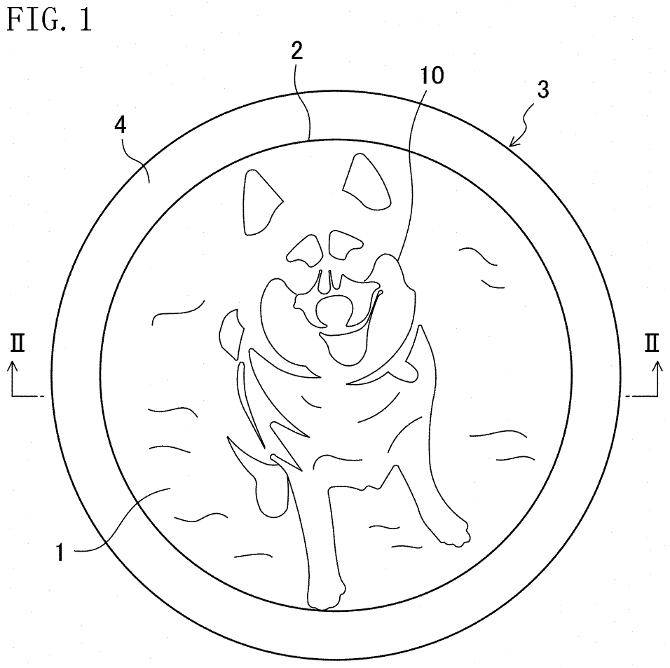

FIG. 1 illustrates a dish 3 including a mold 1 according to a first embodiment of the present invention at a bottom 2. The dish 3 is, for example, a soy sauce dish and has the bottom 2, an edge 4 that extends upward from the circumferential edge of the bottom 2, and legs 5. The edge 4 and/or the legs 5 may be omitted. The shape of the dish 3 is not limited to a circle and may be a square, for example.

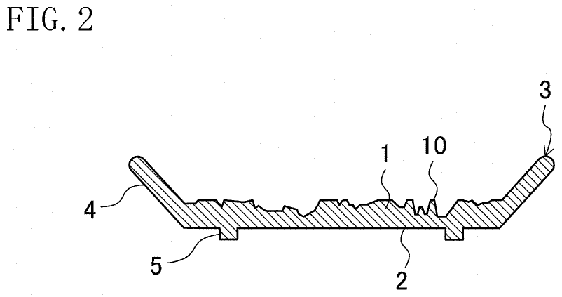

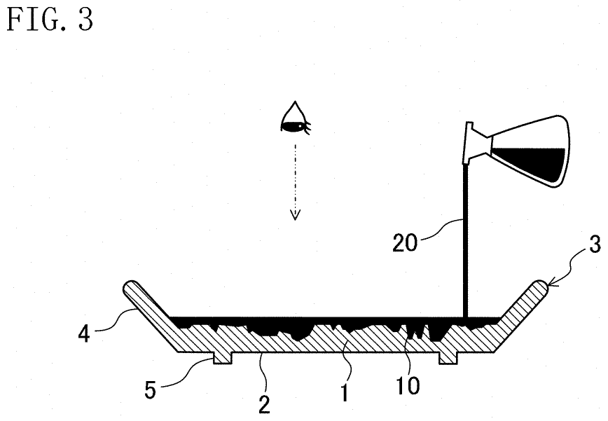

The mold 1 is located on the inner surface side of the dish 3 at the bottom 2 and is used to create an image on the dish 3 as an article. As shown in FIG. 2, the mold 1 has an uneven surface 10 having a depth that varies in accordance with the brightness of an original image, and is covered with a light-transmitting colored material in a color different from the color of the dish 3. The color of the uneven surface 10 is white or milky white, for example. Examples of the colored material include a liquid 20 (shown in FIG. 3) such as a soy sauce, various types of sauces, oil such as olive oil, colored water, and various types of seasoning. The color of the colored material is not particularly limited. The colored material may be in any color. As shown in FIG. 3, the liquid 20 poured onto the bottom 2 covers the uneven surface 10. It is preferred that the depth of the liquid 20 is set such that the uneven surface 10 represents the density.

The liquid 20 is transmissive, that is, capable of transmitting light and is not colorless but colored. Thus, the darker the liquid 20 along the viewer's line of sight is, the deeper the color seems. On the contrary, the shallower the liquid 20 along the viewer's line of sight is, the paler the color seems. With a change in the depth of the liquid 20, the color can be shown almost steplessly. This allows reproduction of high-contrast brightness. The contrast of brightness may be set depending on the shape, depth, and the like of the uneven surface 10.

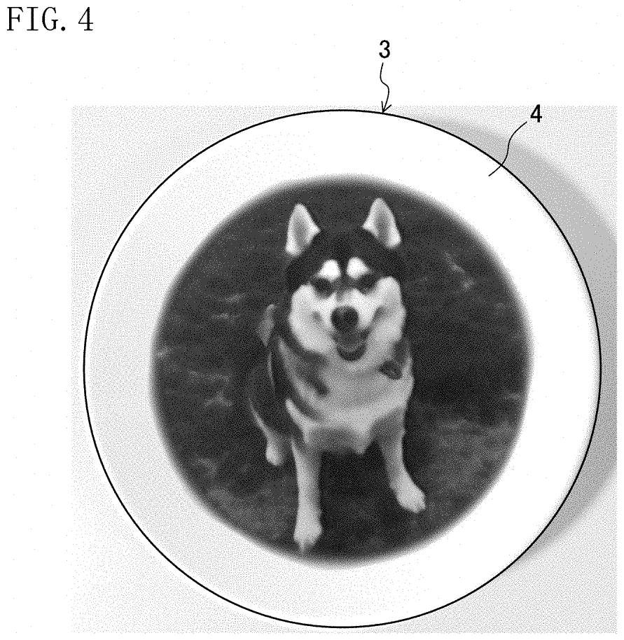

In this example, the shape of the uneven surface 10 is set such that a part with lower brightness (i.e., a darker part) of the original image is located deeper, whereas a part with higher brightness (i.e., a brighter part) of the original image is located shallower. Since the liquid level of the liquid 20 poured onto the bottom 2 is horizontal, the liquid 20 has a greater depth at a deeper part of the uneven surface 10 and a smaller depth at a shallower part of the uneven surface 10. This represents the density of the color as viewed from above. As shown in FIG. 4, an image is created on the bottom 2 of the dish 3. The depth of the uneven surface 10 may vary by about 0.1 mm, for example, although it depends on the material and the processing accuracy. This allows creation of an image with high-contrast brightness.

Unless the colored liquid 20 is poured onto the bottom 2, the uneven surface 10 is merely located on the bottom 2 of the dish 3 and cannot be thus recognized clearly as an image. That is, the action of pouring the liquid 20 changes the appearance of the dish 3 from the state in which an unknown object is present at the bottom 2 to the state in which an image floats up.

Although not shown, the mold 1 may also be located at the bottom of a food container. The mold 1 at the bottom of the food container allows creation of an image by pouring the liquid 20 colored as in the dish 3. Similarly, the mold 1 may be located on an “o-choko” (i.e., a small sake cup), a “masu” (i.e., a wooden box cup for sake), a cup, a Japanese tea cup, a coffee cup, a Japanese soup spoon, and a ladle, for example.

The mold 1 may not be located on the dish 3 or the food container but may be a single body. The mold 1 may also be located on a coaster, an accessory, a key chain, a strap, a candle, a light, a sealing stamp, an eraser, an oil timer, a nameplate, a wind bell, stained glass, and a signboard, for example.

The colored material may be a liquid, a gel, a semi-solid, or clay. The colored material may be a fluid which solidifies from a flowable state, such as a jelly liquid or a pudding liquid and may be a candy, for example.

While requiring a certain transparency as described above, the colored material needs to be colored even lightly, because complete colorlessness and transparency fail to represent the density.

For example, if the colored material has a darker color than the uneven surface 10, the uneven surface 10 may include a recess that is deeper as the brightness of the original image decreases. The deeper part seems thus darker. With this configuration, the brightness of the original image corresponds to the density of the color. The colors of the colored material and the uneven surface 10 may be set opposite thereto. In this case, an image is like what is called a negative film.

For example, if the colored material has a paler color than the uneven surface 10, the uneven surface 10 may include a recess that is deeper as the brightness of the original image increases. The deeper part seems thus darker. With this configuration, the brightness of the original image corresponds to the density of the color.

With respect to a soy sauce dish, for example, the liquid to be poured is determined as a soy sauce. In such a case, the density of the liquid allows setting of the difference between the maximum height and the maximum depth of the uneven surface 10 (i.e., the range for forming the uneven surface 10) for providing the best visual effect. Specifically, a soy sauce is sufficiently dark once exceeding a predetermined depth. A greater depth brings no significant difference in the density. The predetermined depth is thus regarded as the maximum depth of the uneven surface 10. The part of the image with the lowest brightness corresponds to the deepest part of the uneven surface 10. On the other hand, the part of the image with the highest brightness corresponds to the highest part (the part with the maximum height) of the uneven surface 10. Once the color of the soy sauce dish and soy sauce are determined, the difference between the maximum height and the maximum depth of the uneven surface 10 can be set. Within the intermediate region between the maximum height and the maximum depth of the uneven surface 10, the density may vary depending on the depth.

(Manufacturing Method of Mold 1)

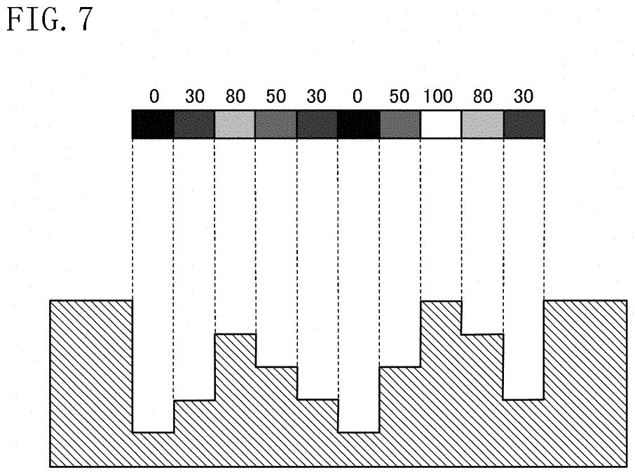

Next, a method of manufacturing the mold 1 will be described. For example, as shown in FIG. 7, brightness information 301 of an original image is used. For example, with a pixel with the lowest brightness regarded as “0” and a pixel with the highest brightness regarded as “100,” the brightness information 301 represents the gradual brightness within the intermediate range using numerical values. With this configuration, the brightness of the original image can be determined as a numerical value. The value indicating the brightness is converted into three-dimensional (3D) distance information 302. The distances are set so that the pixel “0” with the lowest brightness is the lowest (i.e., the deepest) and the pixel “100” with the highest brightness is the highest (i.e., the shallowest). The distances of the pixels with the intermediate brightness are set depending on the respective values. Note that the numerical values 0 to 100 shown in FIG. 7 are mere examples. The gradation may be finer or coarser.

The distance information 302 may be created as data on brightness information or may be created manually. Either may be employed. If the information is created as the data on the brightness information, distance information capable of reproducing the accurate density can be easily created to some extent with skills for operating 3D CAD software. If the information is created manually, it is preferred that a substance with characteristics (e.g., density or viscosity) similar to those of the liquid 20 is poured in advance into a material in the shape of a bowl, and the material is carved with checking the apparent densities. How to create the distance information 302 described above is a mere example. The method is not limited thereto.

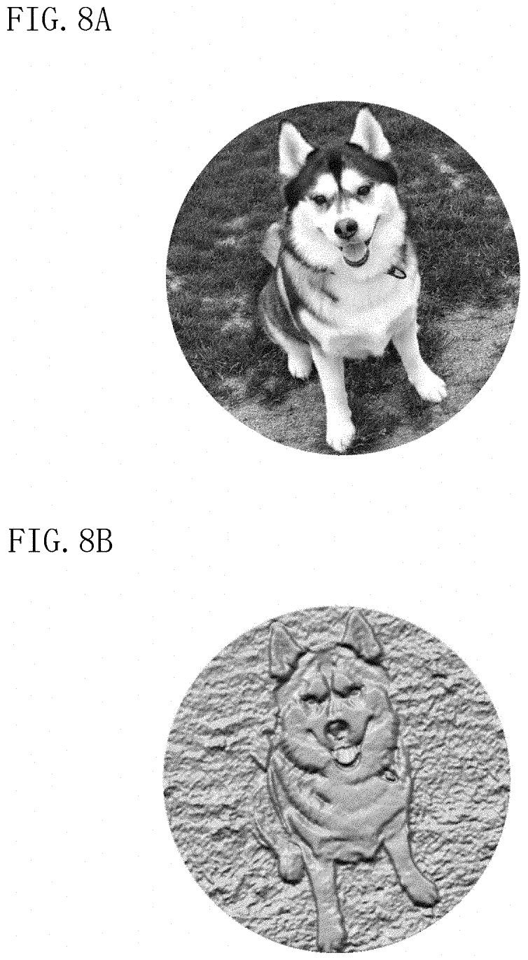

FIG. 8A is a view illustrating brightness information 401 on the original image used in this example. FIG. 8A shows that a brighter pixel has a greater brightness, whereas a darker pixel has a lower brightness. FIG. 8B is a view illustrating an image obtained by converting the brightness information 401 shown in FIG. 8A into distance information 402. The image has a recess with a depth that varies depending on the brightness.

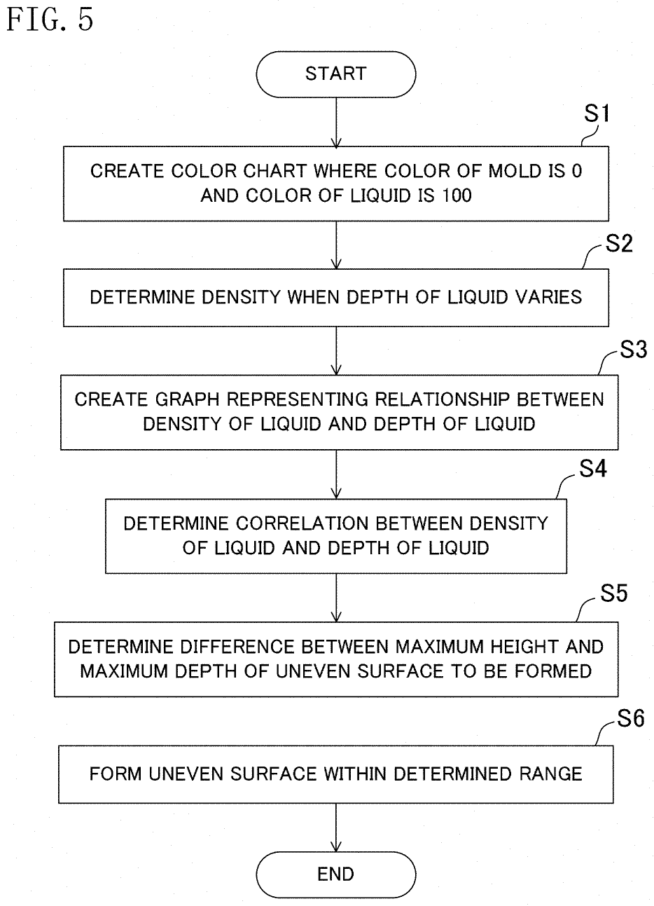

How to properly set the shape of the uneven surface 10 will be described on the basis of a flowchart shown in FIG. 5. In step S1 after the start, a color chart is created, which is divided into 100 sections assuming that the color of the mold 1 is 0, which is the same as the color of the uneven surface 10, and the color of the liquid 20 is 100, which is dark enough to prevent the color of the mold 1 from showing through. At this time, it is preferred that the gradation from “0” to “100” is similar to the color of the liquid 20. In this example, a color chart where on an assumption that the liquid 20 was dark soy sauce, the soy sauce has a yellowish, light brown color at a smaller depth, and the soy sauce becomes more reddish and gradually fades to black with a greater depth.

In step S2, the density is obtained when the depth of the liquid 20 varies. At this time, a member is prepared by molding the material of the mold 1 into the shape of a bowl, and the liquid 20 starts being poured into the bowl member. It is desirable that the color of the material to be used be “0,” while reproducing the environment when viewing. Since the mold 1 serves as the bottom 2 of the soy sauce dish in this example, a color which is the same or similar to the color of the material to be used actually is selected. It is preferred that the bowl member has a flat inner bottom without unevenness. At an uneven inner bottom, a small amount of liquid 20 may flow into the recesses when being poured, which may hinder accurate determination of the density.

As a specific method of determining the density, drops of the liquid 20 are put into the bowl member with a dropper one by one, and a color similar to the density of each drop is selected from the color chart created in step S1 and recorded. That is, an operation is performed to associate the depth of the liquid 20 in the bowl member with the number according to the color chart. At this time, while there are a smaller number of drops, the surface tension causes a non-uniform depth with a certain error. The density is observed with the level of the liquid 20 kept horizontal as much as possible.

Since it is difficult to measure the depth of the liquid 20 in the bowl member in units of 0.1 mm, a change in the density is observed with the drops put with the dropper one by one. This operation is repeated until the density does not change any more. An ordinal number of the last drop is obtained, and the depth of the liquid 20 at that time is divided by the ordinal number to obtain, as a value, an amount of change in the liquid level per drop. For example, the following equation is obtained where the liquid 20 has a depth of 20 mm when the last, 140th drop is put: 20 mm/140 drops=about 0.14286 mm/drop.

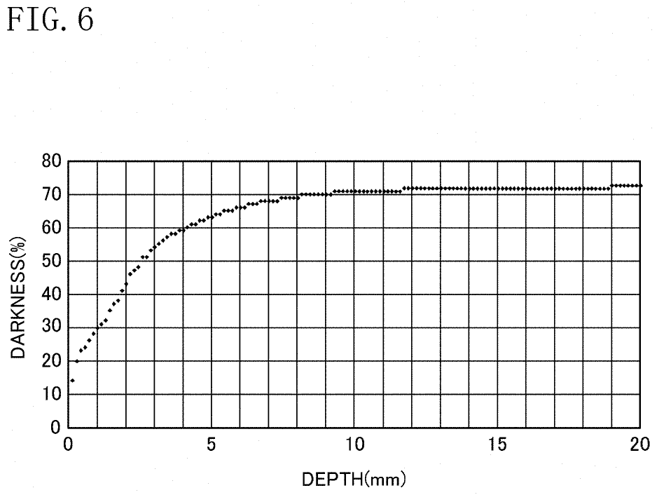

In step S3, a graph is formed which represents the relationship between the density and depth of the liquid. This graph is shown in FIG. 6. In the graph shown in FIG. 6, the horizontal axis represents the depth of the liquid 20, whereas the vertical axis represents the density of the liquid. With an increasing height on the vertical axis, the density of the color increases, that is, the color becomes darker.

In step S4 in the flowchart shown in FIG. 5, the correlation between the density of the liquid 20 and the depth of the liquid is obtained using the graph shown in FIG. 6. The following is found from the graph shown in FIG. 6. The density linearly increases until the depth of the liquid 20 reaches about 3 mm. That is, the density is almost proportional to the depth of the liquid 20. After that, as the depth of the liquid 20 further increases, a gradual curve appears. The density changes less and less even with a further increase in the depth of the liquid 20. Based on this graph, the density is obtained which corresponds to the depth (thickness) of the liquid 20.

In step S5 in the flowchart in FIG. 5, the difference between the maximum height and the maximum depth of the uneven surface 10 to be formed is determined on the basis of the correlation obtained using the graph in FIG. 6 in step S4. As described above, once the depth of the liquid 20 exceeds about 3 mm, the density changes less even with a further increase in the depth of the liquid 20. Thus, the difference between the maximum height and the maximum depth of the uneven surface 10 falls within 3 mm, in which the density is almost proportional to the depth of the liquid 20. In this example, 3 mm was employed. In step S5, the uneven surface 10 is formed within the range obtained in step S4.

If the density of the liquid 20 can be adjusted using a food additive, for example, the difference between the maximum height and the maximum depth of the uneven surface 10 of the mold 1 is determined first and a method proceeds in the reverse order. An appropriate density of the liquid 20 can also be determined with respect to the difference between the maximum height and the maximum depth. When the liquid 20 is yellow, the visual difference is small. Thus, it is difficult to adjust the density. However, if the density is too high relative to the formation range of the uneven surface 10, the gradation cannot be reproduced successfully. The density is thus set in view of the problem.

In theory, a higher visual effect can be provided by setting the maximum depth of the uneven surface 10 as follows. The darker the color of the liquid 20 is, the smaller the maximum depth is, that is, the paler or lighter the color of the liquid 20 is, the larger the maximum depth is. However, if the liquid 20 is in paler color and the uneven surface 10 needs to have a larger maximum depth, the uneven surface 10 has a deeper groove, which causes inconvenience in washing or removing the mold, for example.

For example, assume that a food container has the uneven surface 10 at the bottom and contains a soft food such as pudding (i.e., the food container is a pudding mold). The shape of the uneven surface 10 is transferred onto the pudding. When a caramel sauce is poured onto the pudding slid out of the pudding mold, the shape of the uneven surface 10 is transferred onto the pudding. That is, an image is created on the pudding. At this time, if the uneven surface 10 has a larger maximum depth, a part of the pudding is left on the uneven surface 10 after the pudding has been slid out of the pudding mold. Then, the uneven shape transferred onto the pudding is not identical to the shape of the uneven surface 10 and no fine image is thus created. Therefore, if the food container contains a soft food, it is preferred that the uneven surface 10 has a smaller maximum depth.

It is preferred that the sharpness of the uneven surface 10 may be adjusted in view of the material of the mold 1, the properties of the liquid 20, or the like. This is because it is difficult to wash out the soy sauce, if a soy sauce dish has a sharp groove on the bottom 2, for example. In the case of a pudding mold, finished pudding may lose its shape. In such cases, an idea for reducing the sharpness such as smooth processing of 3D data in advance is desirable.

The amount of the liquid 20 to be poured into the mold 1 may be set so that the liquid level is at the same height as or slightly higher than the tips of projections of the uneven surface 10 in one preferred embodiment. A too large amount of the liquid 20 reduces the visual effect.

Next, the relationship between the colors of the liquid 20 and the uneven surface 10 will be described. It is preferred that the colors of the liquid 20 and the uneven surface 10 may have a higher contrast because the visual effect increases. For example, if a soy sauce dish has the uneven surface 10 at the bottom 2, it is desirable that the uneven surface 10 be in white or a pale color. It is desirable that pudding with a caramel sauce poured thereon be not in a dark color like cafe au lait- or black sesame-flavored pudding but in a pale color like plain pudding. On the contrary, a transparent white milk sauce is poured onto cafe au lait- or black sesame-flavored pudding in a dark color.

Instead of the liquid 20, a semi-solid material may be used. It is however desirable to make the surface of the semi-solid material flat before transferring the shape of the uneven surface 10 thereto. Such an operation of making the surface of the semi-solid material flat may be needed.

The uneven surface 10 may be located on a curved surface of the mold 1.

(Method of Manufacturing Dish)

Next, a method of manufacturing the dish (soy sauce dish) 3 will be described. First, the uneven surface 10 of the mold 1 is formed as 3D data using 3D CAD software. The data is carved based on brightness information 401 of an original image shown in FIG. 8A using an embossing function of the 3D CAD software so that a white part is the shallowest and a black part is the deepest. Alternatively, the white part may be the thickest and the black part may be the thinnest (see, e.g., FIG. 8B). The image used at this time is not necessarily a monochrome image but may be preferred to be monochromatized for checking.

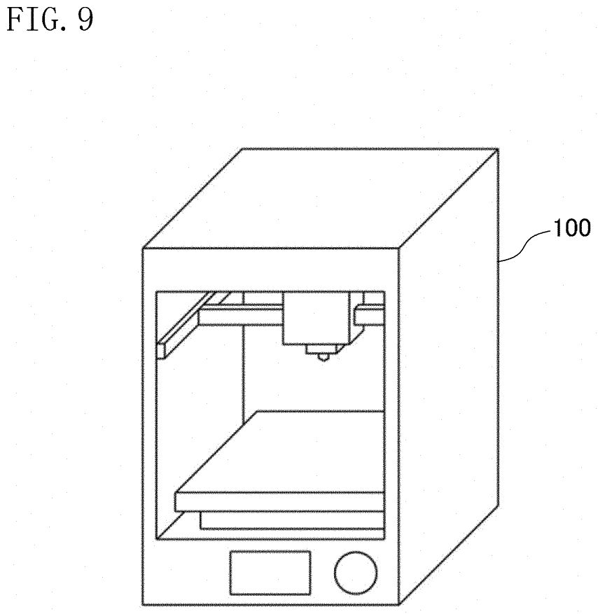

Based on the 3D data of the mold 1 with the uneven surface 10 formed in this manner, an actual mold 1 is obtained. The 3D data is transmitted to the machine tool 100, such as a 3D printer or a cutting machine shown in FIG. 9, to form the mold 1. Alternatively, the mold 1 may be obtained by cutting out the shape of the mold 1 into layers using a laser cutter or the like and stacking the layers. The uneven surface 10 may also be painted in the colors described above.

(Advantages of Embodiment)

As described above, according to this embodiment, the dish 3 has the uneven surface 10 with a depth that varies depending on parts thereof and is used with the uneven surface 10 covered with soy sauce, for example. An image with high-contrast brightness can thus be created on the dish 3 without using any particular printer, engraving machine, laser irradiator, or the like.

### Second Embodiment

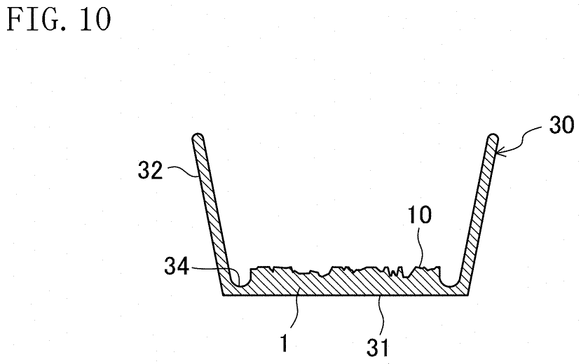

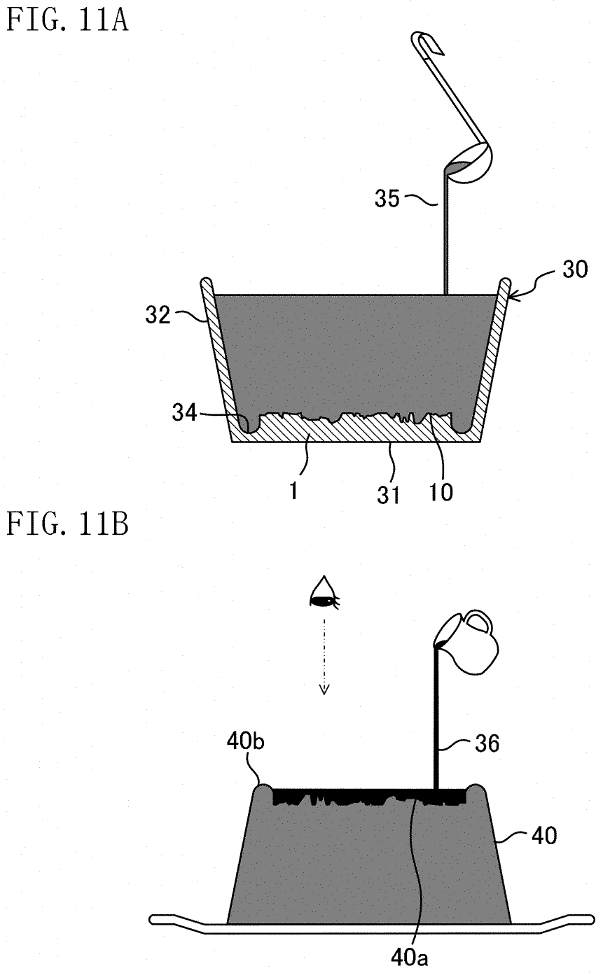

FIG. 10 is a longitudinal sectional view of a food container 30 including a mold 1 according to a second embodiment of the present invention at the bottom 31. The second embodiment is an example where the food container 30 capable of making pudding 40 shown in FIG. 11B has the mold 1. How to form the mold 1 and the uneven surface 10 is the same as in the first embodiment. The detailed description thereof will thus be omitted. Now, differences from the first embodiment will be described in detail.

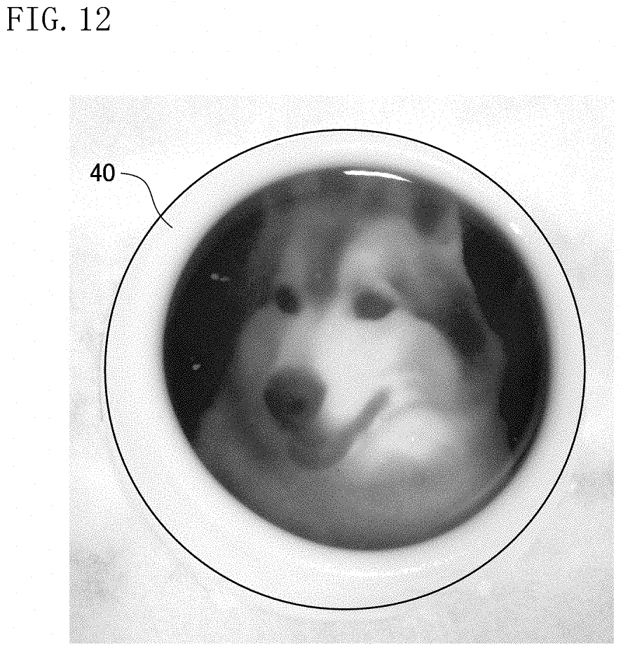

Being capable of making the pudding 40, the food container 30 may thus also be referred to as a pudding mold. The food container 30 includes the bottom 31 and a peripheral wall 32, and has a predetermined depth. As shown in FIG. 11A, a pudding liquid 35, which is a raw pudding mixture of the pudding 40, is poured into the food container 30 to be set. The shape of the uneven surface 10 of the food container 30 can be then transferred onto the pudding 40. As shown in FIG. 11B, an uneven surface 40a can be formed on the top of the finished pudding 40. Poured with a caramel sauce (i.e., a colored material) 36 in a color different from that of the pudding 40, the uneven surface 40a of the pudding 40 is covered with the caramel sauce 36 to create an image as shown in FIG. 12 on the pudding 40.

Accordingly, the pudding 40 has the uneven surface 40a having a depth that varies depending on parts thereof and being covered with a soy sauce 36. An image with high-contrast brightness can thus be created on the pudding 40 without using any particular printer, engraving machine, laser irradiator, or the like.

In the second embodiment, the pudding 40 is in the shape of the uneven surface 10 of the food container 30. That is, the image created on the pudding 40 is a horizontally flipped version of the original image. Although an image whose horizontally flipped image is acceptable is not an issue, it is preferred that an image whose horizontally flipped version is unacceptable may be flipped in advance before forming the uneven surface 10 of the mold 1.

The uneven surface 10 is formed on the food container 30 as follows, contrary to the soy sauce dish according to the first embodiment. The higher the brightness is, the deeper the unevenness is, that is, the lower the brightness is, the shallower the unevenness is. A groove 34 may be formed on the periphery of the inner surface of the bottom 31 of the food container 30. The formation of this groove 34 allows formation of a bank 40b surrounding the uneven surface 40a on the top of the pudding 40 as shown in FIG. 11B. This makes it difficult for a caramel sauce 36 to flow down.

Similarly, tofu or a jelly may also be made. Similarly, for example, silicon may be formed. Similarly, a substance, such as clay, with a low flowability may be molded. In this case, the peripheral wall 32 may be omitted.

In the case of tofu, for example, a ready-made tofu may be prepared and placed on the mold 1. After waiting for a while (e.g., one hour later), the tofu is slid out of the mold 1. The uneven surface 10 of the mold 1 is then transferred onto the tofu to make the tofu with the uneven surface. Upon pouring a soy sauce onto the uneven surface of the tofu, an image is created. One block of tofu may be prepared and the mold 1 may include lines that serve as signs for dividing the tofu into a plurality of pieces. This facilitates the division.

Similarly, the mold 1 may also serve as a waffle mold, a cookie mold, a jelly mold, a candy mold, a popsicle mold, an ice maker, a tofu mold, and a “monaka” (i.e., bean wafer sandwich) mold.

### Third Embodiment

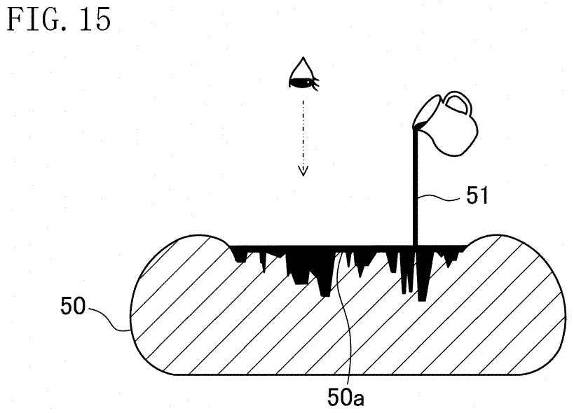

FIG. 13 is a longitudinal-sectional view of a mold 1 according to a third embodiment of the present invention. The mold 1 according to this third embodiment is for molding bread 50 shown in FIG. 15. How to form the mold 1 and the uneven surface 10 is the same as in the first embodiment. The detailed description thereof will thus be omitted. Now, differences from the first embodiment will be described in detail.

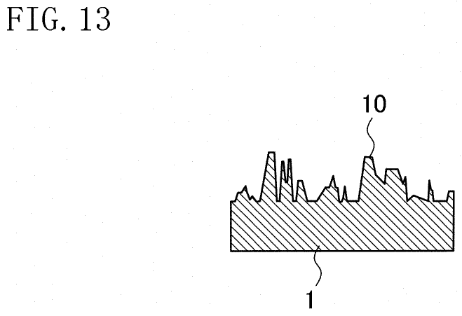

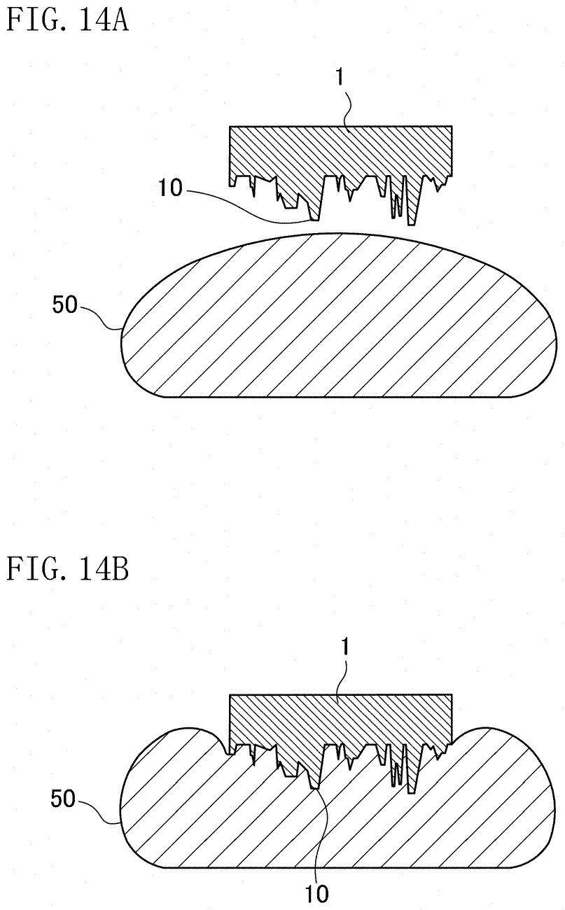

After being arranged to face the surface of the bread 50 as shown in FIG. 14A, the uneven surface 10 of the mold 1 is pressed onto the bread 50 as shown in FIG. 14B. The time for pressing the uneven surface 10 onto the bread 50 may vary depending on the type of the bread 50 or the image to be created. This allows transfer of the shape of the uneven surface 10 of the mold 1 onto the surface of the bread 50. After removing the mold 1, an uneven surface 50a can be formed on the surface of the bread 50 as shown in FIG. 15. Poured with sauce (i.e., a colored material) 51 in a color different from the color of the surface of the bread 50, the uneven surface 50a of the bread 50 is covered with the sauce 51 to create an image on the bread 50.

Accordingly, the bread 50 has the uneven surface 50a having a depth that varies depending on parts thereof and being covered with a sauce 51. An image with high-contrast brightness can be created on the bread 50 without using any particular printer, engraving machine, laser irradiator, or the like.

In this example, the outline of the mold 1 is set smaller than that of the bread 50. After pressing and removing the uneven surface 10 of the mold 1, the periphery of the uneven surface 50a of the bread 50 is raised. Thus, the mold 1 may thus not have to be in a shape with the bank 40b as in the second embodiment (shown in FIG. 11B). The sauce 51 may be a fruit sauce, specifically a blueberry sauce.

Since the bread 50 is elastic, the shape may be slightly restored after pressing and removing the uneven surface 10 of the mold 1. In view of this restoration of the shape, an idea such as forming 3D data with deeper unevenness is desirable.

A similar mold 1 may be used to mold an uneven surface on a pizza, an “okonomiyaki” (i.e., a Japanese pizza), a “manju” (i.e., a bean-paste bun), or the like. Upon pouring a sauce, for example, on the uneven surface, an image is created.

### Fourth Embodiment

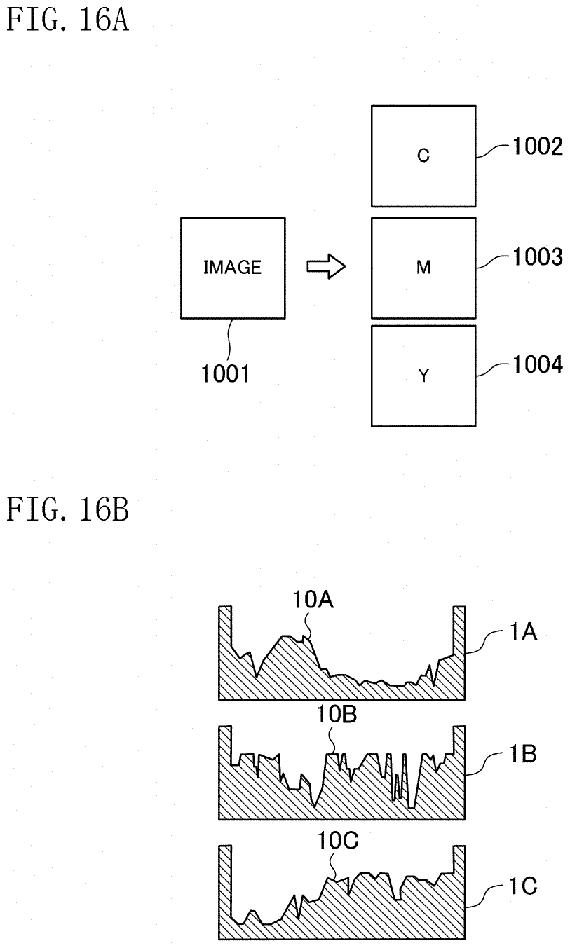

FIGS. 16A and 16B illustrate a fourth embodiment of the present invention in which an image is created by layering jellies in three colors. That is, in the fourth embodiment, the three-color separation jelly is made using layer molds 1A, 1B, and 1C shown in FIG. 16B.

The layer molds 1A, 1B, and 1C may be formed basically in the same manner as in the first embodiment. The original image may be separated into colors. The layer mold 1A may be formed on the basis of an image in cyan only. The layer mold 1B may then be formed on the basis of an image in magenta only. The layer mold 1C may thereafter be formed on the basis of an image in yellow only.

Specifically, the original image data is first separated into colors using image processing software such as Adobe Photoshop by Adobe Systems Incorporated to obtain images in cyan only, magenta only, and yellow only. In FIG. 16A, the reference numeral 1001 denotes original image data, the reference numeral 1002 denotes image data in cyan only, the reference numeral 1003 denotes image data in magenta only, and the reference numeral 1004 denotes image data in yellow only.

At the color separation using such image processing software, it is desirable to change the image mode to a CMYK color mode. At this time, each image is in one color. For example, when an image is created in cyan only, the values of yellow and magenta of image data may be set to 0. After that, the images separated into the respective colors are converted into black and white images, and the contrast is checked. After the color separation, the original colors may have a low contrast, which makes it difficult to form the mold. In this case, the contrast may be adjusted as appropriate for each color. Finally, the respective images are stored to obtain original image data of the layer molds 1A, 1B, and 1C.

In order to reproduce multiple colors, it is desirable to separate an image into, if three colors, cyan, magenta, and yellow. The image may be separated into two, four, or more colors in any combination. In the case of two-color separation, a complementary color combination such as yellow and purple or orange and blue may be used to obtain a larger number of colors.

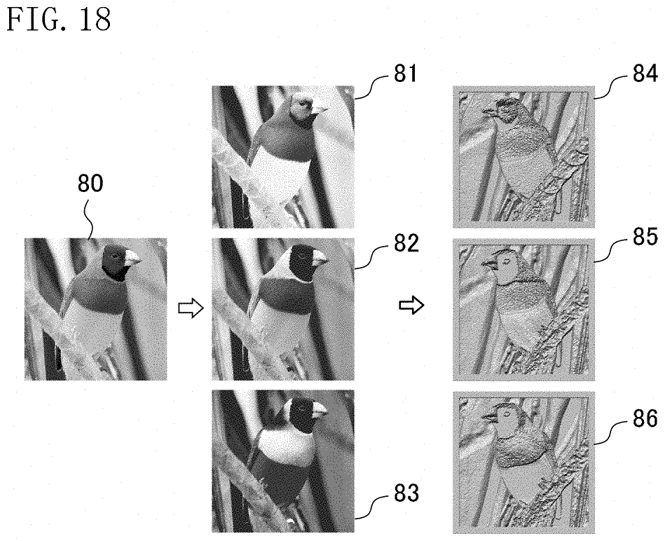

Since the image to be created on the jelly is a horizontally flipped version of the original image, it is desired to horizontally flip the original image in advance before forming the layer molds 1A, 1B, and 1C. The 3D data of the layer molds 1A, 1B, and 1C are created by the method according to the first embodiment based on the images in cyan only, magenta only, and yellow only. Specifically, as shown in FIG. 18, after being prepared, a full-color original image 80 is separated into an image 81 in cyan only, an image 82 in magenta only, and an image 83 in yellow only. Then, 3D data 84 is created on the basis of the image 81 in cyan only, 3D data 85 is created on the basis of the image 82 in magenta only, and 3D data 86 is created on the basis of the image 83 in yellow only.

The layer molds 1A, 1B, and 1C are formed on the basis of the created 3D data 84, 85 and 86, as shown in FIG. 16B. Since each of the layer molds 1A, 1B, and 1C is formed in the shape of a bowl to be able to temporarily contain a jelly that is food, it may also be referred to as a food container.

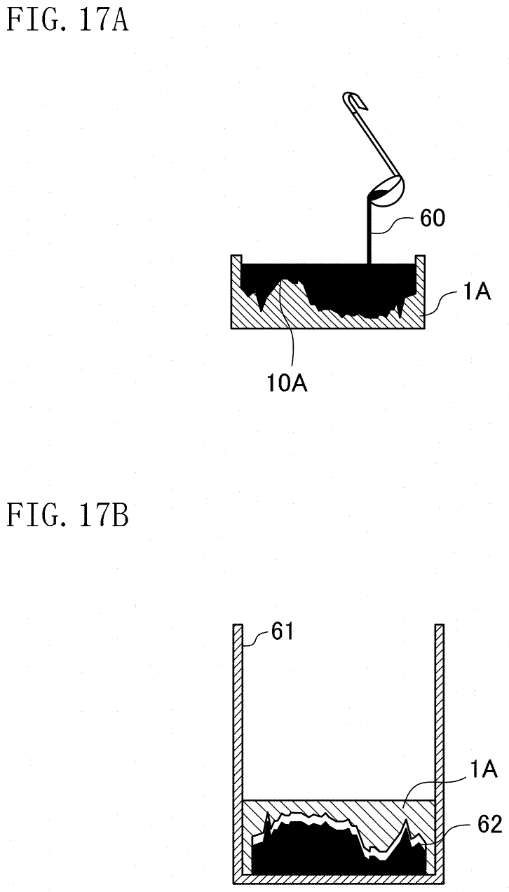

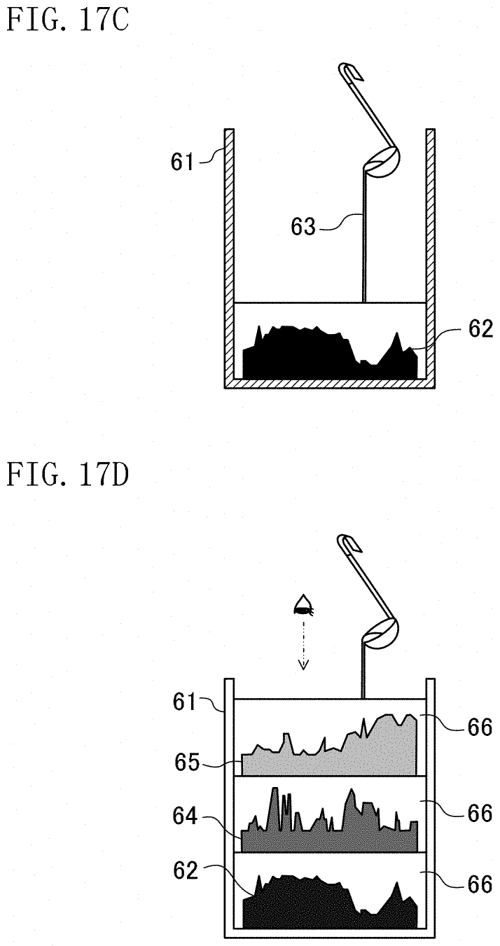

As shown in FIG. 17A, a light-transmitting cyan jelly liquid 60 is poured into the layer mold 1A to set jelly. Accordingly, as shown in FIG. 17B, a cyan jelly 62 in the shape of the uneven surface 10A of the layer mold 1A is set. The finished cyan jelly 62 is moved to the jelly container 61 with the uneven surface facing upward.

Then, as shown in FIG. 17C, a transparent colorless jelly liquid 63 is poured onto the cyan jelly 62 in the jelly container 61 to be set. This allows formation of a transparent colorless jelly layer 66 (shown in FIG. 17D) on the cyan jelly 62.

A light-transmitting magenta jelly liquid (not shown) is poured into the layer mold 1B to set the jelly. Accordingly, as shown in FIG. 17D, a magenta jelly 64 in the shape of the uneven surface 10B of the layer mold 1B is set. The finished magenta jelly 64 is moved to the jelly container 61 with the uneven surface facing upward. The magenta jelly 64 is placed on the top of the transparent colorless jelly layer 66 on the cyan jelly 62. A transparent colorless jelly layer 66 is then made on the magenta jelly 64.

A light-transmitting yellow jelly liquid (not shown) is poured into the layer mold 1C to set jelly. Accordingly, as shown in FIG. 17D, a yellow jelly 65 in the shape of the uneven surface 10C of the layer mold 1C is set. The finished yellow jelly 65 is moved to the jelly container 61 with the uneven surface facing upward. The yellow jelly 65 is placed on the top of the transparent colorless jelly layer 66 on the magenta jelly 64. After that, a transparent colorless jelly layer 66 is made on the yellow jelly 65. The respective centers of the cyan jelly 62, the magenta jelly 64, and the yellow jelly 65 are located on a single vertical line as viewed from above.

The transparent colorless jelly may be replaced with another food material such as agar. These transparent colorless layers reduce diffuse reflection of light as viewed from above. Beside the transparent colorless jelly or agar, a layer may be made of water. It is preferred that water is used in the jelly container 61 or a frame to avoid displacement so that the centers of the cyan jelly 62, the magenta jelly 64, and the yellow jelly 65 are located on the single vertical line as viewed from above.

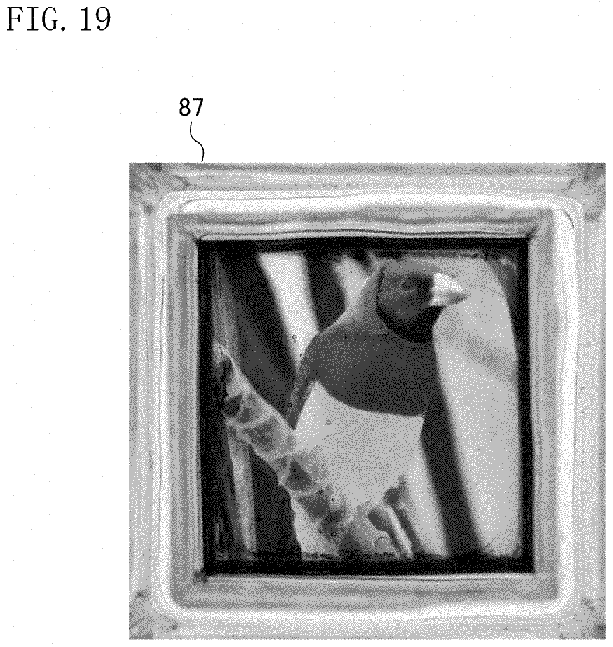

The layering of the cyan jelly 62, the magenta jelly 64, and the yellow jelly 65 allows the full-color image 87 to appear as shown in FIG. 19 when the jelly container 61 is viewed from above.

As shown in FIG. 17, it is preferred that an idea such as the dark cyan jelly 62 at the bottom and the bright yellow jelly 65 on the top is made. On the other hand, having a higher density to represent a fine pattern, the jelly in a dark color such as cyan may be more visible when being located on the top.

Beside the jelly, this technique is also applicable to candies, gummies, amber sweets, and “yokan” (i.e., Japanese sweet bean jelly), for example.

In order to provide a higher visual effect, the jelly may be placed above an LED light under a desk or a dish, for example, so as to be transparent to light.

In the application as a mold for food, the food may not easily slide out of the mold due to friction with the edge of the mold. In such a case, the bottom with the uneven surface and the edge may be formed separately. For example, the inner size of the edge may be the same or larger than the size of the mold with the uneven surface. A bottom may be attached to the edge to serve as a bowl, into which the uneven surface is put. A liquid is then poured into this bowl, which prevents or reduces leakage of the liquid. Further, a hole may be open at the bottom of the bowl described above and closed with a tape or the like while the liquid is poured. After the liquid has been set, the tape may be removed to push the food contained inside the bowl through the hole. This allows the food to smoothly slide out of the bowl.

For example, the inner size of the edge may be the same or larger than the size of the mold with the uneven surface. A bottom may be attached to the edge to serve as a bowl, into which the bottom with the uneven surface is put to serve as a double-bottom container. A liquid is poured then into this container, which prevents or reduces leakage of the liquid. Further, a hole may be open at the bottom of the bowl described above and closed with a tape or the like while the liquid is poured. After the liquid has been set, the tape may be removed to push the food contained inside the bowl through the hole. This allows the food to smoothly slide out of the bowl.

At the superimposition of the separated colors, the obtained image may be blurred in perspective if the layers are thick. In this case, an idea is desirable such as formation of thinner layers, or arrangement of a narrower layer mold in front of the viewer and a wider layer mold apart from the viewer in view of the perspective in advance.

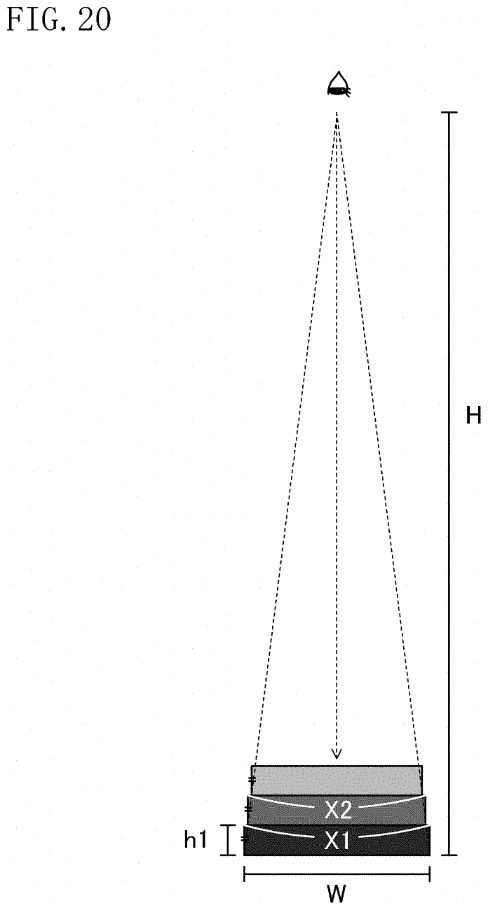

In order to form the molds in view of the perspective, the following equations may be used to obtain the lengths of the bottoms of the different molds. As shown in FIG. 20, the viewpoint is at a height of H, each layer mold has a thickness of h1, the bottom layer mold has a bottom with a length of W, the second layer mold from the bottom has a bottom with a length of X1, and the third layer mold from the bottom has a bottom with a length of X2.

X1={W×(H−h1)}/H

X2={W×(H−h1×2)}/H

The above equations determine only the lengths of the bottoms of the respective molds. Further, if the molds are formed after obtaining the angle in view of the perspective employing a trigonometric function, for example, the blur caused by the perspective may further decrease.

The fourth embodiment allows creation of an image with high-contrast brightness on food such as a jelly without using any particular printer, engraving machine, laser irradiator, or the like.

The embodiments described above are in all respects illustrative only and are not intended to be limiting. Modifications or variations equivalent to the scope of claims fall within the scope of the present invention.

### INDUSTRIAL APPLICABILITY

As described above, the present invention is applicable to preparation of various products including food.

### DESCRIPTION OF REFERENCE CHARACTERS

1 Mold
2 Bottom
3 Dish
10 Uneven Surface
20 Liquid (Colored Material)

1. A mold for creating an image on an article, the mold comprising:
an uneven surface having a depth that varies in accordance with brightness of an original image, and being covered with a light-transmitting colored material in a color different from a color of the article.

2. The mold of claim 1, wherein
the uneven surface is configured such that the lower the brightness of the original image is, the deeper the uneven surface is.

3. The mold of claim 1, wherein
the uneven surface is configured such that the higher the brightness of the original image is, the deeper the uneven surface is.

4. A dish comprising the mold of claim 1 at a bottom.

5. A food container comprising the mold of claim 1 at a bottom.

6. A method of manufacturing the mold of claim 1, the method comprising:
determining brightness of the original image;
determining density corresponding to a thickness of the colored material; and
setting depths of parts of the uneven surface to reproduce the density correlated with the brightness.

7. A dish comprising the mold of claim 2 at a bottom.

8. A food container comprising the mold of claim 2 at a bottom.

9. A dish comprising the mold of claim 3 at a bottom.

10. A food container comprising the mold of claim 3 at a bottom.
